(19) United States
(12) Patent Application Publication
(10) Pub. No.: US 2025/0015848 A1
(43) Pub. Date: Jan. 9, 2025

(54) RECEPTION APPARATUS AND RECEPTION METHOD

(71) Applicant: Panasonic Holdings Corporation, Osaka (JP)

(72) Inventors: Yasuaki YUDA, Kanagawa (JP); Akihiko NISHIO, Osaka (JP); Shotaro MAKI, Kanagawa (JP)

(21) Appl. No.: 18/759,057

(22) Filed: Jun. 28, 2024

(30) Foreign Application Priority Data
Jul. 3, 2023 (JP) 2023-109303

(51) Int. Cl. H04B 7/0456

(52) U.S. Cl. CPC H04B 7/0456

(57) ABSTRACT

A reception apparatus includes reception circuitry which, in operation, receives a signal transmitted in multiple-input multiple-output (MIMO) transmission, and control circuitry which, in operation, controls compensation of phase variation of the signal by using information related to transmission precoding with respect to the signal in a transmission apparatus.

### BACKGROUND

### 1. Technical Field

The present disclosure relates to a reception apparatus and a reception method.

### 2. Background Art

Multiple-input multiple-output (MIMO) transmission is used to improve throughput in cellular wireless communication such as 5G new radio access technology (NR) (see, for example, 3GPP TS 38.300, V15.14.0 “NR; NR and NG-RAN Overall Description; Stage 2 (Release 15)”, 2023-03).

### SUMMARY

However, there is room for study on a method for compensating phase variation.

One non-limiting and exemplary embodiment facilitates providing a reception apparatus and a reception method capable of compensating phase variation.

A reception apparatus according to one exemplary embodiment of the present disclosure includes reception circuitry which, in operation, receives a signal transmitted in multiple-input multiple-output (MIMO) transmission, and control circuitry which, in operation, controls compensation of phase variation of the signal by using information related to transmission precoding with respect to the signal in a transmission apparatus.

It should be noted that general or specific embodiments may be implemented as a system, a method, an integrated circuit, a computer program, a storage medium, or any selective combination thereof.

According to an exemplary embodiment of the present disclosure, phase variation can be compensated.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a block diagram illustrating a configuration example of a part of a transmission apparatus;

FIG. 2 is a block diagram illustrating a configuration example of a part of a reception apparatus;

FIG. 3 is a block diagram illustrating a configuration example of the transmission apparatus;

FIG. 4 is a block diagram illustrating a configuration example of the reception apparatus;

FIG. 5 is a diagram illustrating an example of signal mapping;

FIG. 6 is a block diagram illustrating a configuration example of the transmission apparatus;

FIG. 7 is a block diagram illustrating a configuration example of the reception apparatus;

FIG. 8 is a block diagram illustrating a configuration example of the transmission apparatus; and

FIG. 9 is a block diagram illustrating a configuration example of the reception apparatus.

### DETAILED DESCRIPTION OF PREFERRED EMBODIMENTS

Hereinafter, exemplary embodiments of the present disclosure will be described in detail with reference to the drawings.

For a sixth generation mobile communication system (6G system), virtualization of a system such as a “virtualized terminal” or a “virtualized base station” using a plurality of relay apparatuses or wireless antennas disposed in a distributed manner has been studied (see, for example, Kosuke Yamazaki et al., “PROPOSAL FOR A USER-CENTRIC RAN ARCHITECTURE TOWARDS BEYOND 5G”, IEICE Technical Report, vol. 121, no. 189, SAT 2021-43, pp. 4-10, October 2021; hereinafter, referred to as NPL 2). Such a virtualization system may be referred to as a “virtualization terminal system” or a “distributed antenna system”.

In addition, in the 6G, in addition to a millimeter wave band, utilization of a radio wave having a high frequency such as a terahertz band (or a sub-terahertz band) of 100 GHz or more has been studied. For example, NPL 2 proposes a system using a terahertz wave for communication near a terminal.

In MIMO transmission, a base station (for example, also referred to as a gNB or a gNodeB) and a terminal (for example, also referred to as user equipment (UE)) improve throughput by transmitting and receiving a plurality of data streams by using a plurality of antennas. Since the MIMO transmission is transmission using identical time and frequency resources, a reception-side apparatus performs data stream separation processing (hereinafter, referred to as “MIMO separation processing”). For example, a transmission-side apparatus can improve throughput by performing precoding transmission using a transmission weight suitable for a situation of a MIMO channel (or, a propagation path).

When the high frequency band such as the millimeter wave and the tera wave is used, it is easily influenced by a phase noise or frequency offset generated in a local oscillator. The influence of the phase noise or frequency offset appears as, for example, a common phase error (CPE) or inter-carrier interference (ICI), and may cause deterioration of an error rate. Thus, the reception-side apparatus performs phase variation compensation processing such as CPE compensation or ICI removal in order to reduce the influence of the phase noise or frequency offset.

For the 6G, although the virtualization system using the high frequency band has been studied, the influence of phase variation because of the phase noise or a frequency offset generated in each of a plurality of wireless antennas on communication performance and a countermeasure for the influence have not been sufficiently studied.

For example, when independent (for example, different) phase variation occurs in each of the plurality of wireless antennas on the transmission side and the reception side, there is a possibility that the characteristics deteriorate unless the phase variation compensation is appropriately performed. In addition, when different phase variation occurs in the plurality of wireless antennas after precoding at the time of precoding transmission, a method for appropriately compensating the phase variation in a reception-side apparatus has not been sufficiently studied.

In one non-limiting and exemplary embodiment, for example, a method of performing phase noise compensation when different phase variation occurs in a plurality of wireless antennas after precoding in MIMO transmission will be described.

### First Exemplary Embodiment

In the present exemplary embodiment, a reception apparatus includes a first channel estimator and a second channel estimator, and performs MIMO separation processing by using a channel estimation value of any of the channel estimators according to a predetermined timing.

### Overview of Communication System

A communication system according to an exemplary embodiment of the present disclosure includes at least one transmission apparatus 100 and at least one reception apparatus 200. For example, in the downlink, transmission apparatus 100 may be a base station, and reception apparatus 200 may be a terminal. For example, in the uplink, transmission apparatus 100 may be a terminal, and reception apparatus 200 may be a base station. For example, in the sidelink, transmission apparatus 100 and reception apparatus 200 may be terminals.

Transmission apparatus 100 and reception apparatus 200 perform communication using a plurality of antennas, for example.

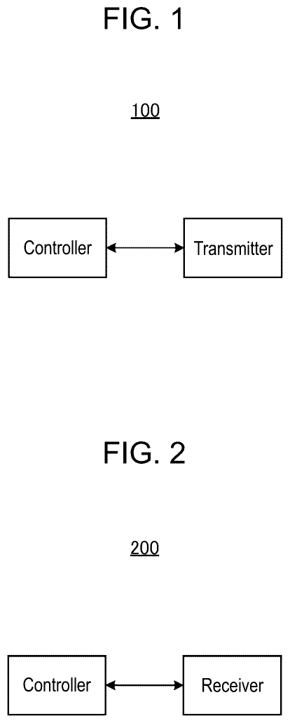

FIG. 1 is a block diagram illustrating a configuration example of a part of transmission apparatus 100. In transmission apparatus 100 in FIG. 1, a controller (for example, corresponding to control circuitry) applies transmission precoding to a signal, a demodulation reference signal (DMRS), and a phase tracking reference signal (PT-RS). A transmitter (for example, corresponding to transmission circuitry) transmits a signal, a demodulation reference signal, and a phase tracking reference signal.

FIG. 2 is a block diagram illustrating a configuration example of a part of reception apparatus 200. In reception apparatus 200 illustrated in FIG. 2, a receiver (for example, corresponding to reception circuitry) receives a signal transmitted in MIMO transmission. The controller (for example, corresponding to control circuitry) performs, on a first time resource (for example, a symbol) on which a demodulation reference signal (for example, DMRS) is positioned, MIMO separation processing on the signal in a MIMO transmission channel by using the demodulation reference signal. Transmission precoding with respect to the signal in transmission apparatus 100 is applied to the demodulation reference signal. The controller (for example, corresponding to control circuitry) performs, on a second time resource (for example, a symbol) on which a phase tracking reference signal (for example, PT-RS) is positioned, the MIMO separation processing by using the phase tracking reference signal. Transmission precoding is applied to the phase tracking reference signal.

### [Configuration Example of Transmission Apparatus]

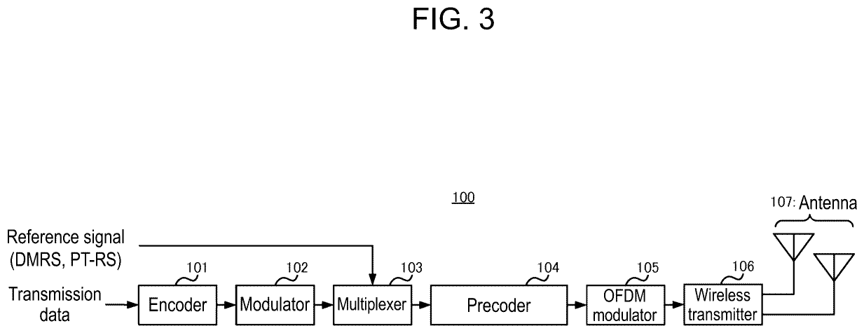

FIG. 3 is a block diagram illustrating an example of a configuration of transmission apparatus 100 according to the present exemplary embodiment. Transmission apparatus 100 illustrated in FIG. 3 may include, for example, encoder 101, modulator 102, multiplexer 103, precoder 104, orthogonal frequency division multiplexing (OFDM) modulator 105, wireless transmitter 106, and antenna 107.

At least one of encoder 101, modulator 102, multiplexer 103, precoder 104, and OFDM modulator 105 illustrated in FIG. 3 may be included in the controller illustrated in FIG. 1. In addition, at least one of wireless transmitter 106 and antenna 107 illustrated in FIG. 3 may be included in the transmitter illustrated in FIG. 1.

Encoder 101 performs error correction coding on a signal (for example, transmission data) by using coding schemes such as turbo coding, low density parity check (LDPC) coding, and polar coding.

For example, modulator 102 maps encoded bit string to an IQ constellation such as quadrature phase shift keying (QPSK) or 16-quadrature amplitude modulation (16QAM) to generate a modulation symbol.

Multiplexer 103 multiplexes, for example, a modulation symbol and a reference signal. The modulation symbol and the reference signal may be positioned in time and frequency resources allocated for each. The reference signal may include a demodulation reference signal (DMRS) used for reception processing and a reference signal (phase tracking reference signal: PT-RS) used for phase tracking, for example.

For example, precoder 104 performs precoding processing (for example, weighting processing on the modulation symbol) for MIMO transmission on the signal input from multiplexer 103. When an identity matrix is used as the precoding matrix, it is equivalent to not performing precoding.

For example, OFDM modulator 105 maps a transmission signal input from precoder 104 to a subcarrier, and converts the transmission signal from a frequency domain signal to a time domain signal by inverse fast Fourier transform (IFFT) processing to generate an OFDM signal. In addition, OFDM modulator 105 adds a cyclic prefix (CP) by copying, to the head, a sample of a part at the end of the OFDM symbol of the signal after IFFT. At this time, OFDM modulator 105 may perform windowing processing for reducing an out-of-band radiation power due to discontinuity between OFDM symbols. Filtering processing may be performed instead of the windowing processing, or another waveform shaping processing for limiting a frequency band may be performed.

Wireless transmitter 106 performs wireless transmission processing such as digital-to-analog conversion, up-conversion to a transmission frequency using a local oscillator, and signal amplification processing, and transmits the signal after the wireless transmission processing from antenna 107.

The processing in each unit that performs the transmission processing may be performed for each system of the plurality of antennas. Each antenna system may process transmission signals to different relay terminals (for example, case of the virtualization terminal system) or access points (APs) (for example, case of the distributed antenna system). Processors such as wireless transmitters that perform processing of the antenna systems may be in an identical housing, or may be disposed in a distributed manner in different housings.

### [Configuration Example of Reception Apparatus]

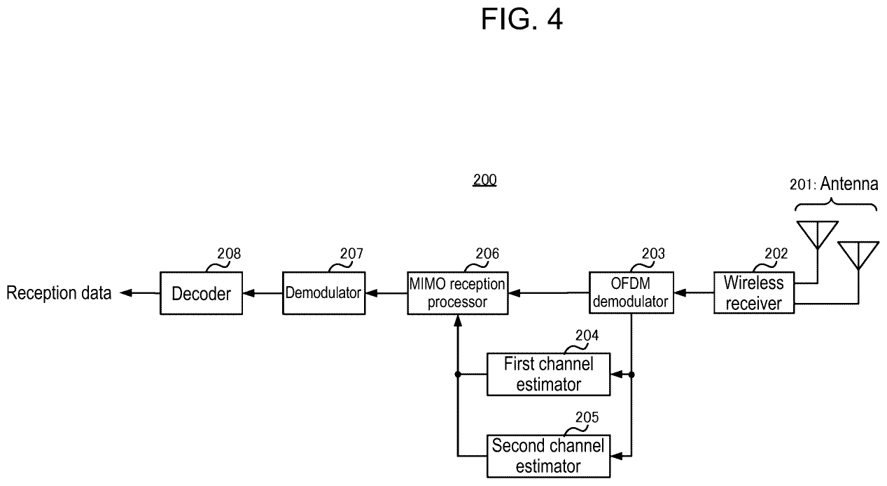

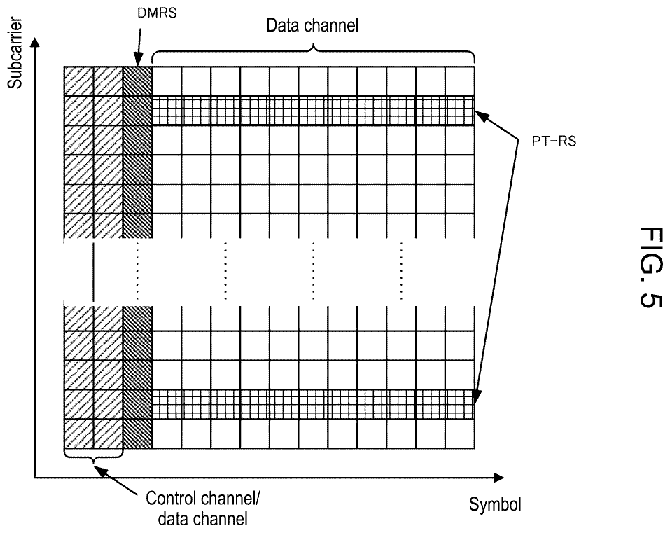

FIG. 4 is a block diagram illustrating an example of a configuration of reception apparatus 200 according to the present exemplary embodiment. Reception apparatus 200 illustrated in FIG. 4 may include, for example, antenna 201, wireless receiver 202, OFDM demodulator 203, first channel estimator 204, second channel estimator 205, MIMO reception processor 206, demodulator 207, and decoder 208.

At least one of antenna 201 and wireless receiver 202 illustrated in FIG. 4 may be included in the receiver illustrated in FIG. 2. At least one of OFDM demodulator 203, first channel estimator 204, second channel estimator 205, MIMO reception processor 206, demodulator 207, and decoder 208 illustrated in FIG. 4 may be included in the controller illustrated in FIG. 2.

Wireless receiver 202 performs wireless reception processing such as down-conversion, analog-digital conversion, and a band-limiting filter on a signal received by antenna 201, for example, to obtain a baseband signal.

For example, OFDM demodulator 203 removes CP added to the signal input from wireless receiver 202, performs fast Fourier transform (FFT) processing on the signal from which CP has been removed, and converts the signal from a time domain signal into a frequency domain signal.

First channel estimator 204 extracts a DMRS reception signal from the OFDM demodulation signal input from OFDM demodulator 203 for a symbol (hereinafter, also referred to as a DMRS symbol) on which the DMRS is transmitted, and estimates a MIMO channel, for example. First channel estimator 204 estimates a MIMO channel by using a replica of a DMRS for a DMRS reception signal, for example.

Second channel estimator 205 extracts a PT-RS reception signal from the OFDM demodulation signal input from OFDM demodulator 203 for a symbol (hereinafter, also referred to as a PT-RS symbol) on which the PT-RS is transmitted, and estimates a MIMO channel, for example. Second channel estimator 205 estimates a MIMO channel by using a PT-RS replica for a PT-RS reception signal, for example. Here, for example, since PT-RS is transmitted sparsely in the frequency direction as compared with DMRS, interpolation in the frequency direction may be performed using an adaptive filter or the like in the channel estimation of PT-RS. In such case, the channel estimation value estimated by first channel estimator 204 and estimated using DMRS may be used.

MIMO reception processor 206 performs MIMO reception processing (or, MIMO separation processing) including channel equalization on the OFDM demodulated signal input from OFDM demodulator 203 by using the channel estimation values estimated by first channel estimator 204 and second channel estimator 205, and separates (or detect) the multiplexed stream signals. For example, on the symbol on which DMRS is transmitted, MIMO reception processor 206 performs MIMO reception processing using the MIMO channel estimation value (for example, a MIMO channel estimation value based on DMRS) estimated by first channel estimator 204, and on the symbol on which PT-RS is transmitted, MIMO reception processor performs MIMO reception processing using the MIMO channel estimation value (for example, a MIMO channel estimation value based on PT-RS) estimated by second channel estimator 205.

Examples of the MIMO reception processing include a separation method based on minimum mean square error (MMSE) standard and a separation method by zero forcing. When MIMO transmission is not performed, MIMO reception processor 206 may perform channel equalization and does not have to detect the stream signal.

Demodulator 207 converts, into a bit string, the modulation symbol modulated by a modulation scheme such as QPSK or 16QAM.

Decoder 208 performs decoding processing on a bit string coded through a coding scheme such as LDPC coding.

Processing in the units that perform reception processing may be performed for each system of the plurality of antennas. Each antenna system may process reception signals from different relay terminals or APs. Processors such as wireless receivers that perform processing of the antenna systems may be in an identical housing, or may be disposed in a distributed manner in different housings.

### [Operation Examples of Transmission Apparatus 100 and Reception Apparatus 200]

Next, an operation example of transmission apparatus 100 and reception apparatus 200 will be described.

In the present exemplary embodiment, stronger phase variation is independently added to the MIMO transmission antenna system on the transmission side (for example, transmission apparatus 100) of the MIMO transmission than on the reception side (for example, reception apparatus 200).

FIG. 5 illustrates an example of signal mapping.

In the example of FIG. 5, the longitudinal direction indicates a subcarrier (frequency), and the lateral direction indicates a symbol (time). DMRS used at the time of demodulation in reception apparatus 200 (reception side) is positioned in the third symbol illustrated in FIG. 5.

DMRS is densely positioned in the subcarrier direction to follow the frequency response of the channel. On the other hand, DMRS may be sparsely positioned in the symbol direction when the time response of the channel is gentle. In the example of FIG. 5, DMRS is positioned in the third symbol, and DMRS is not positioned in the other symbols.

PT-RS is densely positioned in the symbol direction to follow phase variation different for each symbol. On the other hand, since phase variation hardly varies in the frequency direction, PT-RS may be sparsely positioned in the frequency direction. In the example of FIG. 5, PT-RS is positioned for every several subcarriers.

As illustrated in FIG. 5, in addition to DMRS and PT-RS, a control channel or a data channel may be positioned in the first two symbols, and a data channel may be positioned in a region in which PT-RS after the fourth symbol is not positioned.

Next, channel estimation processing and MIMO reception processing for the DMRS symbol will be described.

In the DMRS symbol, first channel estimator 204 extracts the reception signal of DMRS from the OFDM demodulated signal and estimates the MIMO channel by using the replica of DMRS. When data is transmitted on the DMRS symbol, MIMO reception processor 206 performs MIMO reception processing using the MIMO channel estimation value estimated by first channel estimator 204. For example, MIMO reception processor 206 calculates a MMSE reception weight by using the channel estimation value, and multiplies the reception signal by the MMSE reception weight to perform stream separation.

Next, channel estimation processing and MIMO reception processing in each symbol (for example, a symbol on which no DMRS is positioned or a PT-RS symbol) after the DMRS symbol will be described.

In this symbol, second channel estimator 205 extracts the PT-RS reception signal from the OFDM demodulation signal, and estimates the MIMO channel by using the PT-RS replica. For example, as illustrated in FIG. 5, since PT-RS is sparsely positioned in the subcarrier direction, second channel estimator 205 may perform interpolation processing with an adaptive filter or the like to enhance the followability of the channel estimation value in the frequency direction. At the time of this interpolation processing, a channel estimation value estimated by the DMRS symbol can also be used. Then, MIMO reception processor 206 performs MIMO reception processing using the MIMO channel estimation value estimated by second channel estimator 205 on each symbol of PT-RS. For example, MIMO reception processor 206 calculates a MMSE reception weight by using the channel estimation value, and multiplies the reception signal by the MMSE reception weight to perform stream separation.

Phase variation at the time of precoding transmission in the above operation will be described using an equation.

Here, as an example, MIMO transmission with the number of transmission antennas m=2 and the number of reception antennas n=2 will be described. Reception signal rₙ(t) when different phase variation is given between the antennas on the transmission side (for example, transmission apparatus 100) is represented by Equation (1).

$$[ \begin{matrix}{r}_{1} ( t ) \\ {r}_{2} ( t )\end{matrix} ] = [ \begin{matrix}{h}_{11} & {h}_{12} \\ {h}_{21} & {h}_{22}\end{matrix} ] [ \begin{matrix}{e}^{j {φ}_{1} ( t )} & 0 \\ 0 & {e}^{j {φ}_{2} ( t )}\end{matrix} ] [ \begin{matrix}{w}_{11} & {w}_{12} \\ {w}_{21} & {w}_{22}\end{matrix} ] [ \begin{matrix}{s}_{1} ( t ) \\ {s}_{2} ( t )\end{matrix} ] \qquad ( 1 )$$

In Equation (1), hₙₘ represents a MIMO channel between transmission antenna m and receive reception n, and wₘₛ represents a transmission precoding weight for transmission stream sₛ for transmission antenna m. In addition, φₘ (t) represents phase variation in transmission antenna m, and it changes with time t. In Equation (1), the phase variation (for example, φ₁ (t) and φ₂ (t)) is independent (different) for each transmission antenna.

In Equation (1), since different phase variations φ₁ (t) and φ₂ (t) for each transmission antenna are sandwiched between MIMO channel hₙₘ and transmission precoding weight wₘₛ, these components are mixed in reception signal rₙ(t), and thus it is difficult to separate the phase variation components at the reception side to perform phase variation compensation.

Next, a reception signal for the DMRS symbol will be described. Here, assuming that phase variation φₘ (t) in Equation (1) is phase variation φₘ (t_{d}) for the DMRS symbol, reception signal rₙ (t) is represented by Equation (2).

$$[ \begin{matrix}{r}_{1} ( t ) \\ {r}_{2} ( t )\end{matrix} ] = [ \begin{matrix}{h}_{11 , f} & {h}_{12 , f} \\ {h}_{21 , f} & {h}_{22 , f}\end{matrix} ] [ \begin{matrix}{e}^{j {φ}_{1} ( {t}_{d} )} & 0 \\ 0 & {e}^{j {φ}_{2} ( {t}_{d} )}\end{matrix} ] [ \begin{matrix}{w}_{11} & {w}_{12} \\ {w}_{21} & {w}_{22}\end{matrix} ] [ \begin{matrix}{s}_{1} ( t ) \\ {s}_{2} ( t )\end{matrix} ] \qquad ( 2 )$$

In this case, MIMO channel hₙₘ, phase variation φₘ (t_{d}) for the DMRS symbol, and transmission precoding weight wₘₛ can be collectively regarded as an “integrated MIMO channel”. Reception apparatus 200 can estimate the integrated MIMO channel by using DMRS to which transmission precoding is applied for the DMRS symbol.

Thus, in the DMRS symbol, reception apparatus 200 estimates the integrated MIMO channel by using DMRS to which transmission precoding is applied, and performs MIMO reception processing using the estimation value of the integrated MIMO channel, thereby separating a transmission stream. In this manner, reception apparatus 200 performs MIMO separation based on the integrated MIMO channel including the phase fluctuation for the DMRS symbol, and thus can simultaneously compensate the phase fluctuation for the DMRS symbol and perform the MIMO separation.

Next, a reception signal for a symbol (for example, a PT-RS symbol) after the DMRS symbol will be described. Here, when phase variation φₘ (t) in Equation (1) is phase variation φₘ (t_{d}) for the DMRS symbol and relative phase variation Δm (tₚ) from the DMRS symbol for the PT-RS symbol, reception signal rₙ(t) is represented by Equation (3). Here, Δm (t_{d})=0 is satisfied.

$$[ \begin{matrix}{r}_{1} ( t ) \\ {r}_{2} ( t )\end{matrix} ] = [ \begin{matrix}{h}_{11 , f} & {h}_{12 , f} \\ {h}_{21 , f} & {h}_{22 , f}\end{matrix} ] [ \begin{matrix}{e}^{j {φ}_{1} ( {t}_{d} )} \cdot {e}^{j {Δ}_{1} ( {t}_{p} )} & 0 \\ 0 & {e}^{j {φ}_{2} ( {t}_{d} )} \cdot {e}^{j {Δ}_{2} ( {t}_{p} )}\end{matrix} ] [ \begin{matrix}{w}_{11} & {w}_{12} \\ {w}_{21} & {w}_{22}\end{matrix} ] [ \begin{matrix}{s}_{1} ( t ) \\ {s}_{2} ( t )\end{matrix} ] \qquad ( 3 )$$

In this case, like Equation (2), MIMO channel hₙₘ, phase variation Δm (tₚ) for the PT-RS symbol, and transmission precoding weight wₘs can be collectively regarded as an “integrated MIMO channel”. Reception apparatus 200 can estimate the integrated MIMO channel by using PT-RS to which transmission precoding is applied for the PT-RS symbol.

At that time, since PT-RS is sparsely positioned in the frequency direction, the channel estimation value can be sparsely estimated in the frequency direction. Thus, reception apparatus 200 may perform interpolation in the frequency direction on the channel estimation value by using an adaptive filter or the like. In this interpolation processing, reception apparatus 200 may use a channel estimation value estimated for the DMRS symbol.

Thus, in the PT-RS symbol, reception apparatus 200 estimates the integrated MIMO channel by using PT-RS to which transmission precoding is applied, and performs MIMO reception processing using the channel estimation value of the integrated MIMO channel, thereby separating a transmission stream. In this manner, reception apparatus 200 performs MIMO separation based on the integrated MIMO channel including the phase fluctuation for the PT-RS symbol, and thus can simultaneously compensate the phase fluctuation for the PT-RS symbol and perform MIMO separation.

Next, an example in which the virtualization terminal system and the distributed antenna system studied for the 6G will be described as an operation example of the communication system using transmission apparatus 100 and reception apparatus 200 described above.

In a virtualization terminal system, a user terminal and the relay terminal are connected by a radio frequency (for example, tera wave) link, and the user terminal and the relay terminal behave like one terminal apparatus. For example, the relay terminal is used as a remote antenna connected to the user terminal by a link using a radio frequency (for example, terahertz wave or the like).

Here, when each relay terminal is the transmission antenna system of the user terminal, each relay terminal is present at a physically separated position, and thus, an independent local transmitter is used. Thus, the virtualized terminal system communicates using local oscillators that are independent (non-common) among the transmission antenna systems at the user terminal (for example, transmission apparatus 100) side. On the other hand, the base station (for example, reception apparatus 200) may use, for example, a local oscillator common to a plurality of (for example, two) antennas. In this manner, in the uplink in the virtualization terminal system, an independent phase fluctuation may occur for each transmission antenna system in transmission apparatus 100 (for example, the user terminal).

In the distributed antenna system, a plurality of access points (APs) or radio units (RUs) disposed in a distributed manner are connected to a base station (for example, transmission apparatus 100), and each serves as a transmission antenna system of the base station. In the dispersedly disposed APs, independent local oscillators are used. Thus, the distributed antenna system communicates using local oscillators that are independent (non-common) among the transmission antenna systems at the base station (for example, transmission apparatus 100) side. On the other hand, the user terminal (for example, reception apparatus 200) may use, for example, a local oscillator common to a plurality of (for example, two) antennas. In this manner, in the downlink in the distributed antenna system, an independent phase fluctuation may occur for each transmission antenna system in transmission apparatus 100 (for example, a base station).

In this case, transmission precoding is applied to DMRS and PT-RS in addition to the transmission signal, phase noise is added in each of the transmission antenna systems, and then the signals are received by reception apparatus 200 through a MIMO channel. Thus, reception apparatus 200 performs MIMO reception processing based on the channel estimation value using DMRS to which transmission precoding is applied in the DMRS symbol, and performs MIMO reception processing based on the channel estimation value using PT-RS to which transmission precoding is applied in the PT-RS symbol, thereby obtaining a transmission signal (stream).

In this manner, in the present exemplary embodiment, reception apparatus 200 receives a signal transmitted in MIMO transmission, performs MIMO separation processing using DMRS on a symbol on which DMRS to which transmission precoding with respect to a transmission signal in transmission apparatus 100 is applied is positioned, and performs MIMO separation processing using PT-RS on a symbol on which PT-RS to which the transmission precoding is applied is positioned.

When reception apparatus 200 performs MIMO separation processing by using the channel estimation value using either DMRS or PT-RS according to the predetermined timing (for example, either a DMRS symbol or a PT-RS symbol), reception apparatus 200 can perform the stream separation in which the phase fluctuation is compensated even when transmission precoding is applied. Thus, according to the present exemplary embodiment, reception apparatus 200 can appropriately compensate phase variation.

The mapping of the transmission signal (for example, including DMRS and PT-RS) illustrated in FIG. 5 is an example and is not limited. For example, DMRS may be positioned continuously or discontinuously in a plurality of symbols, or may be positioned continuously or discontinuously in the subcarrier direction. For example, PT-RS may be positioned continuously or discontinuously in the symbol direction, or may be positioned continuously or discontinuously on a plurality of subcarriers. For example, PT-RS is not limited to being positioned in a symbol after DMRS, and may be positioned in a symbol before DMRS. DMRS and PT-RS are not limited to be positioned after the third symbol, and may be positioned after the first symbol or the second symbol.

### Second Exemplary Embodiment

In the present exemplary embodiment, the reception apparatus performs MIMO separation processing and phase variation compensation by using the channel estimation value based on DMRS to which the precoding is not applied and the phase variation estimation value based on PT-RS to which the precoding is not applied, and then removes the precoding component to perform stream separation.

A communication system according to an exemplary embodiment of the present disclosure includes at least one transmission apparatus 300 and at least one reception apparatus 400. Transmission apparatus 300 and reception apparatus 400 perform communication using a plurality of antennas, for example.

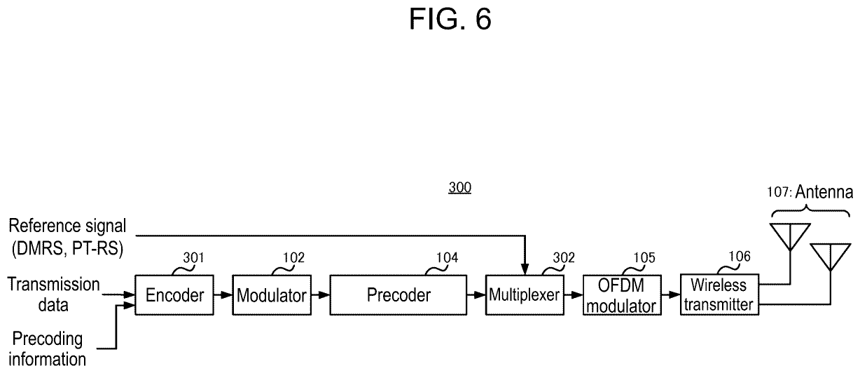

FIG. 6 is a block diagram illustrating a configuration example of transmission apparatus 300 according to the present exemplary embodiment. In transmission apparatus 300 in FIG. 6, operations of encoder 301 and multiplexer 302 are different from those in the first exemplary embodiment.

Encoder 301 performs error correction coding on the transmission data and information (hereinafter, referred to as transmission precoding information) related to the transmission precoding in transmission apparatus 300. The transmission precoding information may be transmitted by, for example, control information of at least one of a control channel and an upper layer.

Multiplexer 302 multiplexes a modulated symbol to which precoding is applied and a reference signal to which no precoding is applied (for example, DMRS and PT-RS). That is, in transmission apparatus 300, transmission precoding is not applied to DMRS and PT-RS.

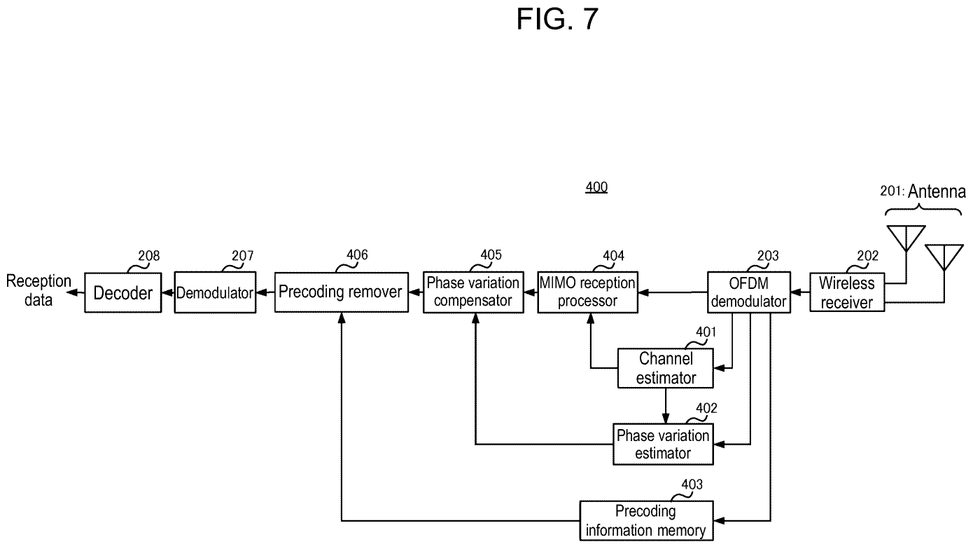

FIG. 7 is a block diagram illustrating a configuration example of reception apparatus 400 according to the present exemplary embodiment. In reception apparatus 400 in FIG. 7, operations of channel estimator 401, phase variation estimator 402, precoding information memory 403, MIMO reception processor 404, phase variation compensator 405, and precoding remover 406 are different from those in the first exemplary embodiment.

Channel estimator 401 extracts a DMRS reception signal from the OFDM demodulated signal input from OFDM demodulator 203, for example, and estimates a MIMO channel. Channel estimator 401 estimates a MIMO channel by using a replica of DMRS for DMRS reception signal, for example.

For example, phase variation estimator 402 extracts a PT-RS reception signal from the OFDM demodulation signal input from OFDM demodulator 203 and estimates the phase variation amount of each symbol. For example, phase variation estimator 402 performs channel estimation on the PT-RS reception signal by using a PT-RS replica. Then, phase variation estimator 402 compares, for example, the channel estimation value estimated using the PT-RS symbol with the channel estimation value estimated using the DMRS symbol in channel estimator 401, and estimates the relative phase variation amount for each symbol from the phase for the DMRS symbol. For example, phase variation estimator 402 estimates different phase variations for individual transmission antennas (for example, antenna 107) of transmission apparatus 300.

Precoding information memory 403 memorizes the transmission precoding information transmitted from transmission apparatus 300 from the OFDM demodulated signal input from OFDM demodulator 203. For example, precoding information memory 403 receives the transmission precoding information notified by the control information of the control channel or the upper layer from transmission apparatus 300 by a predetermined reception method, and memorizes the extracted transmission precoding information.

MIMO reception processor 404 performs MIMO reception processing including channel equalization on the OFDM demodulated signal input from OFDM demodulator 203 by using the channel estimation value estimated by channel estimator 401, and separates the multiplexed signal in the MIMO channel, for example.

Phase variation compensator 405 performs phase variation compensation on the signal separated by MIMO reception processor 404 by using the phase variation estimated by phase variation estimator 402, for example. Phase variation compensator 405 independently compensates phase variation different for each transmission antenna of transmission apparatus 300, for example.

Precoding remover 406 multiplies the signal subjected to the phase variation compensation at phase variation compensator 405 by the inverse matrix of the transmission precoding matrix, thereby separating (or detecting) a transmission stream, for example, based on the transmission precoding information memorized by precoding information memory 403.

### [Operation Example of Transmission Apparatus 300 and Reception Apparatus 400]

Next, an operation example of transmission apparatus 300 and reception apparatus 400 will be described.

In the present exemplary embodiment, as in the first exemplary embodiment, stronger phase variation is independently added to the MIMO transmission antenna system on the transmission side (for example, transmission apparatus 300) of the MIMO transmission than on the reception side (for example, reception apparatus 400).

In the present exemplary embodiment, for example, signal mapping (for example, FIG. 5) similar to that of the first exemplary embodiment may be used as the signal mapping.

In the present exemplary embodiment, in reception apparatus 400, transmission precoding information related to transmission precoding applied to a transmission signal in transmission apparatus 300 is known.

The transmission precoding information may be notified from transmission apparatus 300 to reception apparatus 400 by, for example, control information of at least one of a control channel and an upper layer.

Alternatively, reception apparatus 400 may specify (or estimate) the transmission precoding information by using the reference signal transmitted from transmission apparatus 300. For example, a reference signal to which transmit precoding is applied and a reference signal to which transmit precoding is not applied may be positioned at a location (for example, adjacent subcarriers) at which channel conditions are close to each other. In this case, reception apparatus 400 can estimate transmission precoding by comparing the channel estimation values using the reference signal to which transmission precoding is applied and the reference signal to which transmission precoding is not applied.

Hereinafter, transmission processing in transmission apparatus 300 and reception processing in reception apparatus 400 will be described.

In the present exemplary embodiment, transmission apparatus 300 transmits DMRS and PT-RS without applying transmission precoding, and transmits the transmission data with applying transmission precoding.

Reception apparatus 400 (for example, channel estimator 401) estimates the MIMO channel by using the reception signal of DMRS to which transmission precoding is not applied.

Reception apparatus 400 (for example, phase variation estimator 402) performs channel estimation using a PT-RS reception signal to which transmission precoding is not applied. Then, reception apparatus 400 compares the channel estimation value estimated using PT-RS with the channel estimation value estimated using DMRS on the same subcarrier as the subcarrier on which PT-RS is transmitted, and estimates the phase variation amount from the DMRS symbol for the symbol on which PT-RS is transmitted. Reception apparatus 400 may perform the phase variation estimation processing on each PT-RS symbol.

Reception apparatus 400 (for example, MIMO reception processor 404) performs MIMO separation on the reception signal for each symbol by using the MIMO channel estimation value estimated using DMRS. Reception apparatus 400 (for example, phase variation compensator 405) performs phase variation compensation on the MIMO separated signal by using the estimated phase variation amount for each symbol. Reception apparatus 400 (for example, precoding remover 406) multiplies the signal for which the phase fluctuation is compensated by the inverse matrix of transmission precoding by using the memorized transmission precoding information, thereby separating the signal into a transmission stream.

The above processing will be described using an equation.

As in the first exemplary embodiment, MIMO transmission with the number of transmit antennas m=2 and the number of reception antennas n=2 will be described as an example. Reception signal rₙ(t) when different phase variation is given between the antennas on the transmission side (for example, transmission apparatus 300) is represented by Equation (3).

In Equation (3), separating phase variation φₘ (t_{d}) for the DMRS symbol and phase variation Δm (tₚ) for symbols (for example, PT-RS symbols) after the DMRS symbol, we obtain Equation (4).

$$[ \begin{matrix}{r}_{1} ( t ) \\ {r}_{2} ( t )\end{matrix} ] = {\underbrace{[ \begin{matrix}{h}_{11 , f} & {h}_{12 , f} \\ {h}_{21 , f} & {h}_{22 , f}\end{matrix} ] [ \begin{matrix}{e}^{j {φ}_{1} ( {t}_{d} )} & 0 \\ 0 & {e}^{j {φ}_{2} ( {t}_{d} )}\end{matrix} ]}}_{( A )} {\underbrace{[ \begin{matrix}{e}^{j {Δ}_{1} ( {t}_{p} )} & 0 \\ 0 & {e}^{j {Δ}_{2} ( {t}_{p} )}\end{matrix}}}_{( B )} {\underbrace{[ \begin{matrix}{w}_{11} & {w}_{12} \\ {w}_{21} & {w}_{22}\end{matrix} ]}}_{( C )} [ \begin{matrix}{s}_{1} ( t ) \\ {s}_{2} ( t )\end{matrix} ] \qquad ( 4 )$$

Here, matrix (A) in Equation (4) is a matrix representing an integrated MIMO channel including MIMO channel hₙₘ and phase variation φₘ (t_{d}) for the DMRS symbol. Matrix (A) can be estimated by performing channel estimation using DMRS to which transmission precoding is not applied.

Matrix (B) in Equation (4) is a matrix representing relative phase variation Δm (tₚ) for each symbol (for example, a PT-RS symbol) from the DMRS symbol.

For example, the integrated MIMO channel (for example, corresponding to a matrix obtained by combining matrix (A) and matrix (B)) including MIMO channel hₙm, phase variation φₘ (t_{d}) for the DMRS symbol, and relative phase variation Δₘ (tₚ) for each symbol from the DMRS symbol can be estimated by performing channel estimation using PT-RS to which transmission precoding is not applied. Matrix (B) can be estimated by comparing matrix (A) with the matrix corresponding to the integrated MIMO channel, which is obtained by combining matrix (A) and matrix (B).

In this manner, reception apparatus 400 estimates matrix (A) by using DMRS to which transmission precoding is not applied, estimates matrix (B) by using PT-RS to which transmission precoding is not applied, performs the MIMO separation processing on the reception signal by using matrix (A), and compensates phase variation of the signal after the MIMO separation processing by using matrix (B). As a result, matrix (C) remains in Equation (4). Reception apparatus 400 (for example, precoding remover 406) removes the precoding component by multiplying the inverse matrix of transmission precoding (matrix (C)) based on the transmission precoding information, and separates transmission stream sₛ.

In this manner, in the present exemplary embodiment, reception apparatus 400 receives a signal transmitted in MIMO transmission, and controls compensation of the phase variation of the signal by using the transmission precoding information with respect to the signal in transmission apparatus 300. For example, reception apparatus 400 performs signal separation processing on the MIMO transmission channel by using DMRS to which transmission precoding is not applied, compensates the phase fluctuation of the signal after the separation processing by using PT-RS to which transmission precoding is not applied, and performs stream separation of the signal after the phase fluctuation is compensated based on the transmission precoding information.

This allows reception apparatus 400 to perform stream separation in which the phase fluctuation is compensated even when transmission precoding is applied. In addition, in the present exemplary embodiment, in MIMO transmission, even when different phase variations occur for each of the plurality of transmission antennas after transmission precoding in transmission apparatus 300, reception apparatus 400 can perform phase variation compensation by separating the phase variation component from the reception signal. Thus, according to the present exemplary embodiment, reception apparatus 400 can appropriately compensate phase variation.

### Third Exemplary Embodiment

In the present exemplary embodiment, the reception apparatus estimates a channel estimation value and a phase variation from which a precoding component is removed by using channel estimation values based on DMRS and PT-RS to which precoding is applied, performs MIMO separation processing and phase variation compensation based on the channel estimation value and the phase variation from which the precoding component is removed, and then removes the precoding component to perform stream separation.

A communication system according to an exemplary embodiment of the present disclosure includes at least one transmission apparatus 500 and at least one reception apparatus 600. Transmission apparatus 500 and reception apparatus 600 perform communication using a plurality of antennas, for example.

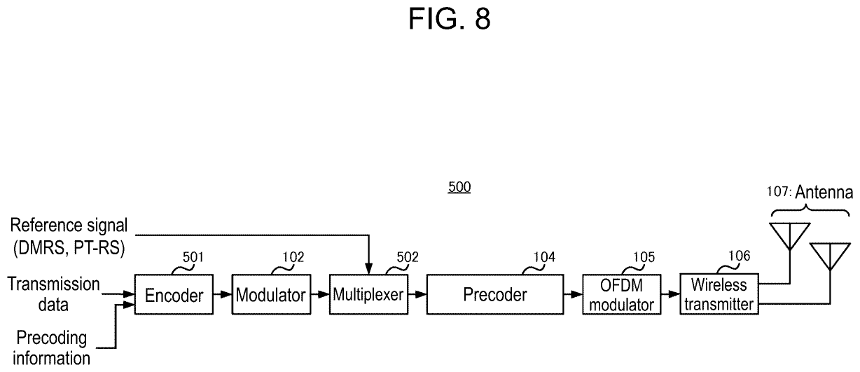

FIG. 8 is a block diagram illustrating a configuration example of transmission apparatus 500 according to the present exemplary embodiment. In transmission apparatus 500 in FIG. 8, operations of encoder 501 and multiplexer 502 are different from those in the first exemplary embodiment.

Encoder 501 performs error correction coding on the transmission data and information (hereinafter, referred to as transmission precoding information) related to transmission precoding in transmission apparatus 500. The transmission precoding information may be transmitted by, for example, at least one piece of control information of a control channel and an upper layer.

Multiplexer 502 multiplexes a modulated symbol before precoding and a reference signal (for example, DMRS and PT-RS). That is, in transmission apparatus 500, the transmission precoding is applied to DMRS and PT-RS.

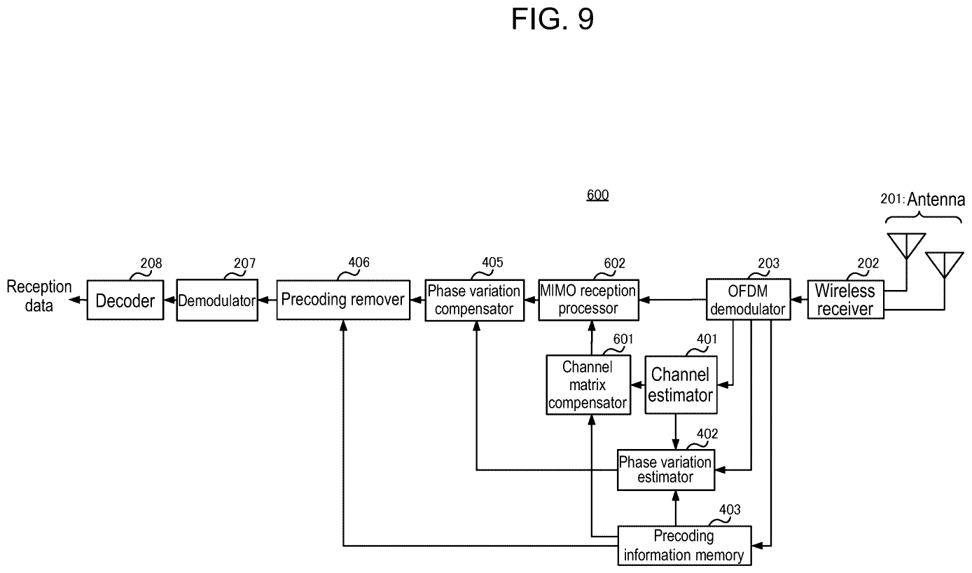

FIG. 9 is a block diagram illustrating a configuration example of reception apparatus 600 according to the present exemplary embodiment. In reception apparatus 600 illustrated in FIG. 9, the operations of channel matrix compensator 601 and MIMO reception processor 602 are different from those of the second exemplary embodiment.

Channel matrix compensator 601 compensates the channel estimation value (for example, a channel estimation value estimated using DMRS) by, for example, multiplying the channel estimation value (for example, a channel matrix) estimated by the channel estimator 401 by the inverse matrix of the transmission precoding matrix based on the transmission precoding information memorized in precoding information memory 403.

For example, MIMO reception processor 602 performs MIMO reception processing including channel equalization on the OFDM demodulated signal input from OFDM demodulator 203 by using the channel estimation value compensated by channel matrix compensator 601, and separates the signals multiplexed in the MIMO channel.

### [Operation Example of Transmission Apparatus 500 and Reception Apparatus 600]

Next, an operation example of transmission apparatus 500 and reception apparatus 600 will be described.

In the present exemplary embodiment, as in the first exemplary embodiment and the second exemplary embodiment, stronger phase variation is independently added to the MIMO transmission antenna system at the transmission side (for example, transmission apparatus 500) of the MIMO transmission than at the reception side (for example, reception apparatus 600).

In the present exemplary embodiment, signal mapping (for example, FIG. 5) similar to that of the first exemplary embodiment may be used as the signal mapping.

In the present exemplary embodiment, in reception apparatus 600, as in the second exemplary embodiment, information related to transmission precoding applied to a transmission signal in transmission apparatus 300 is known. For example, transmission precoding information may be notified from transmission apparatus 300 to reception apparatus 400 by control information of at least one of a control channel and an upper layer as in the second exemplary embodiment, or may be specified (or estimated) by reception apparatus 600 based on a reference signal transmitted from transmission apparatus 500.

Hereinafter, transmission processing in transmission apparatus 500 and reception processing in reception apparatus 600 will be described.

In the present exemplary embodiment, transmission apparatus 500 transmits DMRS and PT-RS by applying transmission precoding as in the case of transmission data.

Reception apparatus 600 (for example, channel estimator 401) estimates the MIMO channel by using the reception signal of DMRS to which transmission precoding is applied.

Reception apparatus 600 (for example, phase variation estimator 402) performs channel estimation using the reception signal of PT-RS to which transmission precoding is applied. Then, as in the second exemplary embodiment, reception apparatus 600 estimates the phase variation amount from the DMRS symbol for the PT-RS symbol. Reception apparatus 600 may perform this phase variation estimation processing for each PT-RS symbol.

For example, reception apparatus 600 (for example, channel matrix compensator 601) compensates the channel estimation value (for example, a channel matrix) of the MIMO channel by multiplying the channel estimation value estimated using DMRS by the inverse matrix of the transmission precoding matrix based on the transmission precoding information memorized by precoding information memory 403.

Reception apparatus 600 (for example, MIMO reception processor 602) performs MIMO separation of the reception signal for each symbol by using the compensated channel estimation value of the MIMO channel. Reception apparatus 400 (for example, phase variation compensator 405) performs phase variation compensation on the MIMO separated signal by using the estimated phase variation amount for each symbol. Reception apparatus 400 (for example, precoding remover 406) multiplies the signal for which the phase fluctuation is compensated by the inverse matrix of transmission precoding by using the memorized transmission precoding information, thereby separating the signal into a transmission stream.

The above processing will be described using an equation.

As in the first exemplary embodiment and the second exemplary embodiment, MIMO transmission with the number of transmit antennas m=2 and the number of reception antennas n=2 will be described as an example. Reception signal rₙ(t) when different phase variation is given between the antennas on the transmission side (for example, transmission apparatus 500) is represented by Equation (3).

As in the second exemplary embodiment, for the reception signal represented by Equation (3), separating phase variation φₘ (t_{d}) for the DMRS symbol and phase variation Δₘ (tₚ) for symbols (for example, PT-RS symbols) after the DMRS symbol, we obtain Equation (4). Here, Equation (5) shows a case where matrix (D) and matrix (E) are further added as grouping of matrixes shown in Equation (4).

$$[ \begin{matrix}{r}_{1} ( t ) \\ {r}_{2} ( t )\end{matrix} ] = {\underbrace{{\underbrace{{\underbrace{[ \begin{matrix}{h}_{11 , f} & {h}_{12 , f} \\ {h}_{21 , f} & {h}_{22 , f}\end{matrix} ] [ \begin{matrix}{e}^{j {φ}_{1} ( {t}_{d} )} & 0 \\ 0 & {e}^{j {φ}_{2} ( {t}_{d} )}\end{matrix} ]}}_{( A )} {\underbrace{[ \begin{matrix}{e}^{j {Δ}_{1} ( {t}_{p} )} & 0 \\ 0 & {e}^{j {Δ}_{2} ( {t}_{p} )}\end{matrix}}}_{( B )}}}_{( D )} {\underbrace{[ \begin{matrix}{w}_{11} & {w}_{12} \\ {w}_{21} & {w}_{22}\end{matrix} ]}}_{( C )}}}_{( E )} [ \begin{matrix}{s}_{1} ( t ) \\ {s}_{2} ( t )\end{matrix} ] \qquad ( 5 )$$

Matrix (A), matrix (B), and matrix (C) in Equation (5) are the same as those in Equation (4).

Matrix (D) in Equation (5) is a matrix obtained by combining matrix (A) and matrix (B), and is a matrix representing an integrated MIMO channel including MIMO channel hₙₘ, phase variation φₘ (t_{d}) for the DMRS symbol, and relative phase variation Δₘ (tₚ) for each symbol from the DMRS symbol.

Matrix (E) in Equation (5) is a combination of matrix (D) and matrix (C), and is an integrated MIMO channel including MIMO channel hₙₘ, phase variation φₘ (t_{d}) for the DMRS symbol, relative phase variation Δₘ (tₚ) for each symbol from the DMRS symbol, and transmission precoding (transmission weight). Matrix (E) is an entire MIMO channel between the transmit antenna end of transmission apparatus 500 and the reception antenna end of reception apparatus 600.

Matrix (E), which is the entire MIMO channel, can be estimated by performing channel estimation using DMRS or PT-RS to which transmission precoding is applied.

Matrix (D), which is the integrated MIMO channel including MIMO channel hₙₘ, phase variation φₘ (t_{d}) for the DMRS symbol, and relative phase variation Δₘ (tₚ) for each symbol from the DMRS symbol, can be derived by removing the components of matrix (C) corresponding to known transmission precoding by reception apparatus 600 from matrix (E). For example, matrix (D) can be derived by multiplying matrix (E) by an inverse matrix of matrix (C), which is transmission precoding, from the right side.

An operation example of MIMO separation in reception apparatus 600 (for example, channel matrix compensator 601 and MIMO reception processor 602) will be described.

In the DMRS symbol, relative phase variation Δₘ (t_{d}) of symbols after DMRS in matrix (E) is 0. Thus, in the DMRS symbol, matrix (B) is an identity matrix, and matrix (E) is actually an integrated MIMO channel including matrix (A) and matrix (C).

Then, in the DMRS symbol, reception apparatus 600 (for example, channel matrix compensator 601) multiplies an inverse matrix of transmission precoding (for example, matrix (C)) by an integrated MIMO channel including matrix (A) and matrix (C). For example, reception apparatus 600 derives matrix (A) by multiplying the inverse matrix of matrix (C) from the right of the integrated MIMO channel (for example, a matrix obtained by combining matrix (A) and matrix (C)). This processing is processing (or channel matrix compensation processing) of deriving an integrated MIMO channel (for example, matrix (A)) including MIMO channel hₙₘ and phase variation φₘ (t_{d}) for the DMRS symbol by removing the transmission precoding component (for example, matrix (C)) from the entire MIMO channel (for example, matrix (E)).

MIMO reception processor 602 performs MIMO separation processing on the reception signal input from OFDM demodulator 203 by using the integrated MIMO channel (for example, matrix (A)) derived by channel matrix compensator 601.

Next, an operation example of phase variation estimation in reception apparatus 600 (for example, phase variation estimator 402 and phase variation compensator 405) will be described.

For the symbols after DMRS (for example, a PT-RS symbol), reception apparatus 600 estimates matrix (E) using PT-RS to which the transmission precoding is applied, and multiplies matrix (E) by the inverse matrix of transmission precoding (for example, matrix (C)). For example, reception apparatus 600 derives matrix (D) that is an integrated MIMO channel including matrix (A) and matrix (B) by multiplying the inverse matrix of matrix (C) from the right of matrix (E) to remove the transmission precoding components from the entire MIMO channel.

Then, reception apparatus 600 estimates matrix (B) representing relative phase variation amount Δₘ (tₚ) of symbols after DMRS by comparing matrix (A) estimated for the DMRS symbol with derived matrix (D). For example, reception apparatus 600 performs the relative phase fluctuation estimation processing for each symbol after the DMRS symbol.

Reception apparatus 600 compensates the phase fluctuation of the signal subjected to the MIMO reception processing in each symbol by using the estimated phase fluctuation amount (for example, matrix (B)) in each symbol, for example.

In this manner, reception apparatus 600 estimates matrix (A) by using DMRS to which transmission precoding is applied and the transmission precoding information, estimates matrix (B) by using PT-RS to which transmission precoding is applied and the transmission precoding information, performs MIMO separation processing on the reception signal by using matrix (A), and compensates the phase variation of the signal after the MIMO separation processing by using matrix (B). As a result, matrix (C) remains in Equation (5). Reception apparatus 600 (for example, precoding remover 406) can remove the precoding component by multiplying the inverse matrix of transmission precoding (matrix (C)) based on the transmission precoding information, and separates transmission stream sₛ.

In this manner, in the present exemplary embodiment, reception apparatus 600 receives a signal transmitted in MIMO transmission, and controls compensation of the phase variation of the signal by using the transmission precoding information with respect to the signal in transmission apparatus 500. For example, reception apparatus 600 performs signal separation processing on the MIMO transmission channel by using DMRS to which transmission precoding is applied and transmission precoding information, compensates the phase fluctuation of the signal after the separation processing by using PT-RS to which transmission precoding is applied and transmission precoding information, and performs stream separation on the signal after the phase fluctuation is compensated based on the transmission precoding information.

This allows reception apparatus 600 to perform stream separation in which the phase fluctuation is compensated even when transmission precoding is applied. In addition, in the present exemplary embodiment, in MIMO transmission, even when different phase variations occur for each of the plurality of transmission antennas after transmission precoding in transmission apparatus 500 and when transmission precoding is applied to DMRS and PT-RS, reception apparatus 600 can perform phase variation compensation by separating the phase variation component from the reception signal. Thus, according to the present exemplary embodiment, reception apparatus 600 can appropriately compensate the phase fluctuation.

Each exemplary embodiment of the present disclosure has been described above.

In the above-described exemplary embodiments, although the example using the tera wave or the millimeter wave has been described, other frequency bands can also be applied.

In addition, in the above-described exemplary embodiments, although the case of the virtualization terminal or the distributed antenna system using the relay terminal has been described, the present disclosure can also be applied to a normal terminal or base station (for example, in which antennas are not disposed in a distributed manner).

In addition, although the method of compensating phase variation due to phase noise and frequency offset has been described, the method of compensating phase variation may be applied to phase variation due to both phase noise and frequency offset, or may be applied to phase variation due to either phase noise or frequency offset.

The millimeter wave band may be read as a frequency of “frequency range 2 (FR2)”. The sub 6 GHz band may be read as a frequency of “frequency range 1 (FR1)”.

The reference signal is not limited to DMRS and PT-RS, and may be another signal. For example, the reference signal may be any of a channel state information-reference signal (CSI-RS), a tracking reference signal (TRS), a cell-specific reference signal (CRS), and a sounding reference signal (SRS). DMRS and PT-RS may be handled as reference signals of the same type without being distinguished from each other.

The unit of the time resource is not limited to the symbol, and may be a unit of another time resource. The unit of the frequency resource is not limited to the subcarrier, and may be a unit of another frequency resource.

In the above-described exemplary embodiments, the notation “ . . . unit” used for each component may be replaced with another notation such as “ . . . circuit (circuitry)”, “ . . . device”, or “ . . . module”.

The present disclosure can be realized by software, hardware, or software in cooperation with hardware. Each functional block used in the description of the above exemplary embodiment may be partially or entirely achieved as a large-scale integration (LSI) which is integrated circuitry, and each processing described in the above exemplary embodiment may be partially or entirely controlled by one LSI or a combination of LSIs. The LSI may be configured by individual chips, or may be configured by one chip to include some or all of the functional blocks. The LSI may include an input and an output of data. The LSI may be referred to as integrated circuitry (IC), system LSI, super LSI, or ultra LSI depending on the degree of integration.

However, the technique of implementing integrated circuitry is not limited to the LSI and may be realized by using dedicated circuitry, a general-purpose processor, or a special-purpose processor. In addition, a Field Programmable Gate Array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may include a transceiver and processing/control circuitry. The transceiver may include and/or function as a receiver and a transmitter. The transceiver, as the transmitter and receiver, may include an RF (radio frequency) module including amplifiers, RF modulators/demodulators and the like, and one or more antennas. Some non-limiting examples of such communication apparatus include a phone (e.g., cellular (cell) phone, smart phone), a tablet, a personal computer (PC) (e.g., laptop, desktop, notebook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may include a device such as a controller or a sensor which is coupled to a communication device performing a function of communication described in the present disclosure. For example, the communication apparatus may include a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

A reception apparatus according to one exemplary embodiment of the present disclosure includes reception circuitry which, in operation, receives a signal transmitted in multiple-input multiple-output (MIMO) transmission, and control circuitry which, in operation, controls compensation of phase variation of the signal by using information related to transmission precoding with respect to the signal in a transmission apparatus.

In one exemplary embodiment of the present disclosure, the reception circuitry receives a demodulation reference signal to which the transmission precoding is not applied and a phase tracking reference signal to which the transmission precoding is not applied, and the control circuitry performs separation processing on the signal transmitted in MIMO transmission by using the demodulation reference signal, compensates phase variation of the signal after the separation processing by using the phase tracking reference signal, and performs stream separation on the signal after the phase variation is compensated, the stream separation being based on the information.

In one exemplary embodiment of the present disclosure, the reception circuitry receives a demodulation reference signal to which the transmission precoding is applied and a phase tracking reference signal to which the transmission precoding is applied, and the control circuitry performs separation processing on the signal transmitted in MIMO transmission by using the demodulation reference signal and the information, compensates phase variation of the signal after the separation processing by using the phase tracking reference signal and the information, and performs stream separation on the signal after the phase variation is compensated, the stream separation being based on the information.

A reception apparatus according to one exemplary embodiment of the present disclosure includes reception circuitry which, in operation, receives a signal transmitted in multiple-input multiple-output (MIMO) transmission, and control circuitry which, in operation, performs, on a first time resource on which a demodulation reference signal is positioned, separation processing on the signal transmitted in MIMO transmission by using the demodulation reference signal, transmission precoding with respect to the signal in a transmission apparatus being applied to the demodulation reference signal, and performs, on a second time resource on which a phase tracking reference signal is positioned, the separation processing by using the phase tracking reference signal, transmission precoding being applied to the phase tracking reference signal.

In one exemplary embodiment of the present disclosure, on the second time resource, the control circuitry performs interpolation in a frequency direction on a channel estimation value estimated using the phase tracking reference signal by using a channel estimation value estimated using the demodulation reference signal.

In a reception method according to an exemplary embodiment of the present disclosure, a reception apparatus receives a signal transmitted in multiple-input multiple-output (MIMO) transmission, and controls compensation of phase variation of the signal by using information related to transmission precoding with respect to the signal in a transmission apparatus.

In a reception method according to an exemplary embodiment of the present disclosure, a reception apparatus receives a signal transmitted in multiple-input multiple-output (MIMO) transmission, performs, on a first time resource on which a demodulation reference signal is positioned, separation processing on the signal transmitted in MIMO transmission by using the demodulation reference signal, transmission precoding with respect to the signal in a transmission apparatus being applied to the demodulation reference signal, and performs, on a second time resource on which a phase tracking reference signal is positioned, the separation processing by using the phase tracking reference signal, the transmission precoding being applied to the phase tracking reference signal.

One aspect of the present disclosure is useful for a wireless communication system.

1. A reception apparatus comprising:
reception circuitry which, in operation, receives a signal transmitted in multiple-input multiple-output (MIMO) transmission; and
control circuitry which, in operation, controls compensation of phase variation of the signal by using information related to transmission precoding with respect to the signal in a transmission apparatus.

2. The reception apparatus according to claim 1, wherein
the reception circuitry receives a demodulation reference signal to which the transmission precoding is not applied and a phase tracking reference signal to which the transmission precoding is not applied, and
the control circuitry
performs separation processing on the signal transmitted in MIMO transmission by using the demodulation reference signal,
compensates phase variation of the signal after the separation processing by using the phase tracking reference signal, and
performs stream separation on the signal after the phase variation is compensated, the stream separation being based on the information.

3. The reception apparatus according to claim 1, wherein
the reception circuitry receives a demodulation reference signal to which the transmission precoding is applied and a phase tracking reference signal to which the transmission precoding is applied, and
the control circuitry
performs separation processing on the signal transmitted in MIMO transmission by using the demodulation reference signal and the information,
compensates phase variation of the signal after the separation processing by using the phase tracking reference signal and the information, and
performs stream separation on the signal after the phase variation is compensated, the stream separation being based on the information.

4. A reception apparatus comprising:
reception circuitry which, in operation, receives a signal transmitted in multiple-input multiple-output (MIMO) transmission; and
control circuitry which, in operation, performs, on a first time resource on which a demodulation reference signal is positioned, separation processing on the signal transmitted in MIMO transmission by using the demodulation reference signal, transmission precoding with respect to the signal in a transmission apparatus being applied to the demodulation reference signal, and performs, on a second time resource on which a phase tracking reference signal is positioned, the separation processing by using the phase tracking reference signal, transmission precoding being applied to the phase tracking reference signal.

5. The reception apparatus according to claim 4, wherein on the second time resource, the control circuitry performs interpolation in a frequency direction on a channel estimation value estimated using the phase tracking reference signal by using a channel estimation value estimated using the demodulation reference signal.

6. A method of reception performed by a reception apparatus, the method comprising:
receiving a signal transmitted in multiple-input multiple-output (MIMO) transmission; and
controlling compensation of phase variation of the signal by using information related to transmission precoding with respect to the signal in a transmission apparatus.

7. A method of reception performed by a reception apparatus, the method comprising:
receiving a signal transmitted in multiple-input multiple-output (MIMO) transmission;
performing, on a first time resource on which a demodulation reference signal is positioned, separation processing on the signal transmitted in MIMO transmission by using the demodulation reference signal, transmission precoding with respect to the signal in a transmission apparatus being applied to the demodulation reference signal; and
performing, on a second time resource on which a phase tracking reference signal is positioned, the separation processing by using the phase tracking reference signal, the transmission precoding being applied to the phase tracking reference signal.
